(19) United States
(12) Patent Application Publication
(10) Pub. No.: US 2026/0155419 A1
(43) Pub. Date: Jun. 4, 2026

(54) REDOX FLOW BATTERY SYSTEM WITH REPLACEABLE BARRIER ELECTROLYTE SOLUTION

(71) Applicant: RTX CORPORATION, Arlington, VA (US)

(72) Inventor: James Demetrios Saraidaridis, East Hartford, CT (US)

(21) Appl. No.: 18/965,437

(22) Filed: Dec. 2, 2024

(51) Int. Cl. H01M 8/18; H01M 8/0271; H01M 8/0289; H01M 8/04276

(52) U.S. Cl. CPC H01M 8/188; H01M 8/0271; H01M 8/0289; H01M 8/04276

(57) ABSTRACT

A redox flow battery system includes a redox flow battery and an ancillary cell that is fluidly connected to the redox flow battery. The ancillary cell includes a barrier electrolyte chamber containing a barrier electrolyte solution. The ancillary cell is designed to adjust either the state of charge or the pH of first and second electrolyte solutions in the redox flow battery.

### BACKGROUND

Flow batteries, also known as redox flow batteries or redox flow cells, are designed to convert electrical energy into chemical energy that can be stored and later released when there is demand. As an example, a flow battery may be used with a renewable energy system, such as a wind-powered system, to store energy that exceeds consumer demand and later release that energy when there is greater demand.

A basic flow battery includes a redox flow cell having a negative electrode and a positive electrode separated by an ion-exchange membrane. A negative electrolyte is delivered to the negative electrode and a positive electrolyte is delivered to the positive electrode to drive an electrochemically reversible redox reaction. Upon charging, the electrical energy supplied causes an electrochemical reduction reaction in one electrolyte and an oxidation reaction in the other electrolyte. The ion-exchange membrane prevents the electrolytes from mixing but permits selected ions to pass through to maintain electroneutrality. Upon discharge, the chemical energy contained in the electrolyte is released in the reverse reactions and electrical energy can be drawn from the electrodes.

### SUMMARY

A redox flow battery system according to an example of the present disclosure includes a redox flow battery and an ancillary cell. The ancillary cell is fluidly connected with the redox flow battery, and further includes a barrier electrolyte chamber containing a barrier electrolyte solution. The ancillary cell is configured to treat at least one of a positive electrolyte solution or a negative electrolyte solution of the redox flow battery by adjusting at least one of a state of charge or a pH of the positive electrolyte solution or negative electrolyte solution.

In a further embodiment of any of the foregoing embodiments, the ancillary cell further includes a first flow field and a first electrode arranged adjacent to the first flow field. The ancillary cell also includes a second flow field and a second electrode arranged adjacent to the second flow field and a first membrane arranged adjacent to the first electrode. Additionally, the ancillary cell includes a second membrane arranged adjacent to the second electrode wherein the barrier electrolyte chamber is arranged between the first membrane and the second membrane.

In a further embodiment of any of the foregoing embodiments, the barrier electrolyte solution is selected from a group consisting of hydrogen chloride, sulfuric acid, salts containing lithium, sodium, potassium, cesium, magnesium, calcium cations and halide, hydroxide, sulfur-containing, nitrogen-containing, and carbon-containing anions, and combinations thereof.

In a further embodiment of any of the foregoing embodiments, the barrier electrolyte chamber is fluidly connected to a treatment chamber that is configured to purify the barrier electrolyte solution circulated between the barrier electrolyte chamber and the treatment chamber.

In a further embodiment of any of the foregoing embodiments, the barrier electrolyte solution is a stagnant barrier electrolyte solution.

In a further embodiment of any of the foregoing embodiments, the ancillary cell further includes a third membrane that partitions the barrier electrolyte chamber into two sub-chambers.

In a further embodiment of any of the foregoing embodiments, the redox flow battery includes a cell having first and second electrodes and an ion-exchange layer arranged therebetween. The cell supports electrochemically reversible redox reactions of the positive electrolyte solution and the negative electrolyte solution. First and second circulation loops are fluidly connected with the first and second electrodes, respectively, of the cell. First and second electrolyte storage vessels are in the first and second circulation loops, respectively. The first electrolyte storage vessel contains the negative electrolyte solution and a first byproduct gas, and the second electrolyte storage vessel contains the positive electrolyte solution and a second byproduct gas.

In a further embodiment of any of the foregoing embodiments, the redox flow battery system further includes a first feed line fluidly connecting the first electrolyte storage vessel with the first flow field of the ancillary cell. The first feed line is operable to communicate the negative electrolyte solution from the first electrolyte storage vessel to the first flow field of the ancillary cell. The redox flow battery system further includes a second feed line fluidly connecting the second electrolyte storage vessel with the second flow field of the ancillary cell. The second feed line operable to communicate the positive electrolyte solution from the second electrolyte storage vessel to the second flow field of the ancillary cell. The redox flow battery system further includes a first return line fluidly connecting the first flow field of the ancillary cell and the first electrolyte storage vessel. The first return line is operable to communicate treated positive electrolyte solution from the first flow field of the ancillary cell to the first electrolyte storage. The redox flow battery system further includes a second return line fluidly connecting the second flow field with the second electrolyte storage vessel. The second return line is operable to communicate treated negative electrolyte solution from the second flow field to the second electrolyte storage vessel.

In a further embodiment of any of the foregoing embodiments, the redox flow battery system further includes a first feed line fluidly connecting the first electrolyte storage vessel with the first flow field of the ancillary cell. The first feed line is operable to communicate the first byproduct gas from the first electrolyte storage vessel to the first flow field of the ancillary cell. The redox flow battery system further includes a second feed line fluidly connecting the first electrolyte storage vessel with the second flow field of the ancillary cell. The second feed line is operable to communicate the negative electrolyte solution from the first electrolyte storage vessel to the second flow field of the ancillary cell. The redox flow battery system further includes a first return line fluidly connecting the first flow field of the ancillary cell with the first electrolyte storage vessel. The first return line is operable to communicate residual first byproduct gas from the first flow field of the ancillary cell to the first electrolyte storage. The redox flow battery system further includes a second return line fluidly connecting the second flow field of the ancillary cell with the first electrolyte storage vessel. The second return line is operable to communicate treated negative electrolyte solution from the second flow field of the ancillary cell to the first electrolyte storage.

In a further embodiment of any of the foregoing embodiments, the redox flow battery system further includes a first feed line fluidly connecting the second electrolyte storage vessel with the first flow field of the ancillary cell. The first feed line is operable to communicate the positive electrolyte solution from the first electrolyte storage vessel to the first flow field of the ancillary cell. The redox flow battery system further includes a second feed line fluidly connecting the second electrolyte storage vessel with the second flow field of the ancillary cell. The second feed line is operable to communicate the second byproduct gas from the second electrolyte storage vessel to the second flow field of the ancillary cell. The flow battery system further includes a first return line fluidly connecting the first flow field of the ancillary cell with the second electrolyte storage vessel. The first return line is operable to communicate treated positive electrolyte solution from the first flow field of the ancillary cell to the second electrolyte storage vessel. The redox flow battery system further includes a second return line fluidly connecting the second flow field of the ancillary cell with the second electrolyte storage vessel. The second return line is operable to communicate residual second byproduct gas from the second flow field of the ancillary cell to the second electrolyte storage vessel.

In a further embodiment of any of the foregoing embodiments, the redox flow battery system further includes a first feed line fluidly connecting the first electrolyte storage vessel with the first flow field of the ancillary cell. The first feed line is operable to communicate the first byproduct gas from the first electrolyte storage vessel to the first flow field of the ancillary cell. The redox flow battery system further includes a second feed line fluidly connecting the second electrolyte storage vessel with the second flow field of the ancillary cell. The second feed line is operable to communicate the second byproduct gas from the second electrolyte storage vessel to the second flow field of the ancillary cell. The redox flow battery system further includes a first return line fluidly connecting the first flow field of the ancillary cell with the first electrolyte storage vessel. The first return line is operable to communicate residual first byproduct gas from the first flow field of the ancillary cell to the first electrolyte storage vessel. The redox flow battery system further includes a second return line fluidly connecting the second flow field of the ancillary cell with the second electrolyte storage vessel. The second return line is operable to communicate residual second byproduct gas from the second flow field of the ancillary cell to the second electrolyte storage vessel.

In a further embodiment of any of the foregoing embodiments, the redox flow battery system further includes a reservoir containing an electrolyzable solution. The redox flow battery system further includes a first feed line fluidly connecting the reservoir with an electrolysis chamber arranged within the ancillary cell. The first feed line is operable to communicate the electrolyzable solution from the reservoir to the electrolysis chamber. The redox flow battery system further includes a second feed line fluidly connecting the second electrolyte storage vessel with the second flow field of the ancillary cell. The second feed line is operable to communicate the positive electrolyte solution from the second electrolyte storage vessel to the second flow field of the ancillary cell. The redox flow battery system further includes a vent line fluidly connected to the electrolysis chamber. The vent line is operable to communicate gases from the electrolysis chamber out of the ancillary cell. The redox flow battery system further includes a return line fluidly connecting the second flow field of the ancillary cell and the second electrolyte storage vessel. The return line operable to communicate treated positive electrolyte solution from the second flow field of the ancillary cell to the second electrolyte storage vessel.

In a further embodiment of any of the foregoing embodiments, the redox flow battery system further includes a reservoir containing an electrolyzable solution. The redox flow battery system further includes a first feed line fluidly connecting the reservoir with an electrolysis chamber arranged within the ancillary cell. The first feed line is operable to communicate the electrolyzable solution from the reservoir to the electrolysis chamber. The redox flow battery system further includes a second feed line fluidly connecting the first electrolyte storage vessel with the first flow field of the ancillary cell. The second feed line is operable to communicate the negative electrolyte solution from the first electrolyte storage vessel to the first flow field of the ancillary cell. The redox flow battery system further includes a vent line fluidly connected to the electrolysis chamber. The vent line is operable to communicate gases from the electrolysis chamber out of the ancillary cell. The redox flow battery system further includes a return line fluidly connecting the first flow field of the ancillary cell and the first electrolyte storage vessel. The return line is operable to communicate treated negative electrolyte solution from the first flow field of the ancillary cell to the first electrolyte storage vessel.

A redox flow battery system according to an example of the present disclosure includes a redox flow battery that includes a cell having first and second electrodes and an ion-exchange layer arranged there between. The cell supports electrochemically reversible redox reactions of a positive electrolyte solution and a negative electrolyte solution. The redox flow battery system further includes first and second circulation loops fluidly connected with the first and second electrodes, respectively, of the cell. The redox flow battery system further includes first and second electrolyte storage vessels in the first and second circulation loops, respectively. The first electrolyte storage vessel contains the negative electrolyte solution and the second electrolyte storage vessel contains the positive electrolyte solution. The redox flow battery system further includes at least one ancillary cell fluidly connected with the redox flow battery. The at least one ancillary cell is configured to treat at least one of the positive electrolyte solution or the negative electrolyte solution of the redox flow battery by adjusting at least one of a state of charge or a pH of the positive electrolyte solution or negative electrolyte solution.

In a further embodiment of any of the foregoing embodiments, the at least one ancillary cell further includes a first flow field and a first electrode arranged adjacent to the first flow field. The at least one ancillary cell further includes a second flow field and a second electrode arranged adjacent to the second flow field. The at least one ancillary cell further includes a first membrane arranged adjacent to the first electrode and a second membrane arranged adjacent to the second electrode. The at least one ancillary cell further includes a barrier electrolyte chamber containing a barrier electrolyte solution. The barrier electrolyte chamber is arranged between the first membrane and the second membrane. The at least one ancillary cell may include a first ancillary cell and a second ancillary cell. The first ancillary cell is operable to adjust the state of charge of one of the positive electrolyte solution or the negative electrolyte solution and the second ancillary cell is operable to adjust the pH of one of the positive electrolyte solution or the negative electrolyte solution.

A method for a redox flow battery system according to an example of the present disclosure that includes feeding a first electrolyte solution or a first byproduct gas in circulation with a redox flow battery into an ancillary cell. The method for a redox flow battery system further includes oxidizing the first electrolyte solution or the first byproduct gas in the ancillary cell to produce free electrons and ions. The method for a redox flow battery system further includes feeding a second electrolyte solution or a second byproduct gas into the ancillary cell. The method for a redox flow battery system further includes reducing the second electrolyte solution or the second byproduct gas in the ancillary cell.

In a further embodiment of any of the foregoing embodiments, the ancillary cell includes a first flow field and a first electrode arranged adjacent to the first flow field. The ancillary cell further includes a second flow field and a second electrode arranged adjacent to the second flow field. The ancillary cell further includes a first membrane arranged adjacent to the first electrode and a second membrane arranged adjacent to the second electrode. The ancillary cell further includes a barrier electrolyte chamber arranged between the first membrane and the second membrane, the barrier electrolyte chamber containing a barrier electrolyte solution.

In a further embodiment of any of the foregoing embodiments, the method for a redox flow battery system further includes monitoring an operating parameter of the barrier electrolyte solution by generating a measured value of a property of the barrier electrolyte solution. The method for a redox flow battery system further includes comparing the measured value to a threshold operating value and in response to the measured value exceeding the threshold operating value, evacuating the barrier electrolyte solution from the barrier electrolyte chamber and providing a fresh barrier electrolyte solution into the barrier electrolyte chamber.

In a further embodiment of any of the foregoing embodiments, the method for a redox flow battery system further includes the operating parameter of the barrier electrolyte solution is at least one of an ion concentration, conductivity, or a pH value.

In a further embodiment of any of the foregoing embodiments, the method for a redox flow battery system further includes treating the barrier electrolyte solution that has been evacuated from the barrier electrolyte chamber in a treatment chamber to produce the fresh barrier electrolyte solution, and returning the fresh barrier electrolyte solution to the barrier electrolyte chamber.

### BRIEF DESCRIPTION OF THE DRAWINGS

The various features and advantages of the disclosed examples will become apparent to those skilled in the art from the following detailed description.

In this disclosure, like reference numerals designate like elements where appropriate, and reference numerals with the addition of one-hundred or multiples thereof designate modified elements. The modified elements are understood to incorporate the same benefits and/or features of the corresponding original elements.

The drawings that accompany the detailed description can be briefly described as follows.

FIG. 1 illustrates an example redox flow battery system.

FIG. 2 illustrates an example ancillary cell with a barrier electrolyte chamber.

FIG. 3 illustrates another example ancillary cell with a first and second barrier electrolyte chamber.

FIG. 4 illustrates another example redox flow battery system for consuming a gaseous byproduct in a headspace of a first vessel storing anolyte.

FIG. 5 illustrates another example redox flow battery system for consuming a gaseous byproduct in a headspace of a second vessel storing catholyte.

FIG. 6 illustrates another example redox flow battery system for consuming gaseous byproducts in the headspace of the first and second vessel storing anolyte and catholyte, respectively.

FIG. 7 illustrates another example redox flow battery system for managing the pH, or SOC, or both, of catholyte.

FIG. 8 illustrates another example redox flow battery system for managing the pH, or SOC, or both of anolyte.

### DETAILED DESCRIPTION OF THE PREFERRED EMBODIMENT

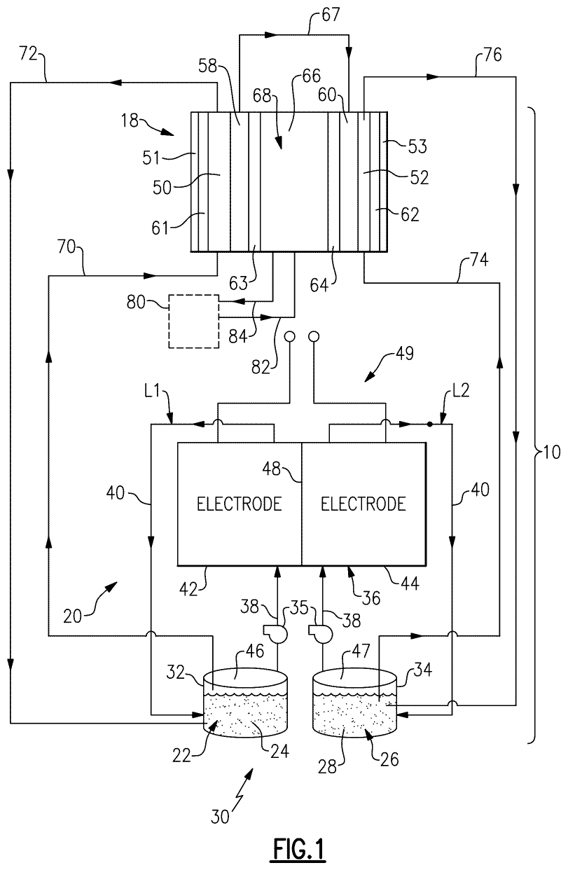

FIG. 1 schematically shows portions of an example redox flow battery system 10 that includes an ancillary cell 18 and redox flow battery 20 (“RFB 20”) for selectively storing and discharging electrical energy. As an example, the RFB 20 can be used to convert electrical energy to chemical energy. At a later time, the RFB 20 can be used to convert the chemical energy back into electrical energy that may be provided to an electric grid, for example. The RFB 20 thus provides for electrical energy storage.

The RFB 20 includes a first electrolyte solution 22 that has at least one electrochemically active species 24 that functions in a redox pair with regard to a second electrolyte solution 26 that has at least one electrochemically active species 28. The electrochemically active species 24, 28 include ions that have multiple, reversible oxidation states in a selected base solvent, such as but not limited to, water, acetonitrile, dimethoxyethane, and propylene carbonate. In some examples, the multiple oxidation states are non-zero oxidation states, such as transition metals including but not limited to vanadium, iron, manganese, chromium, zinc, molybdenum, sulfur, cerium, lead, tin, titanium, germanium, ferricyanide, ferrocyanide and functional combinations thereof. In some cases, the transition metals can be modified by bound chelating agents, including but not limited to ethylendiaminetetraacetic acid (EDTA) or other aminopolycarboxylic acids, acetylacetonates, bipyridyls, and phenanthrenes. In some examples, the multiple oxidation states can include the zero oxidation state if the element is readily soluble in the selected liquid solution in the zero oxidation state. Such elements can include the halogens, such as bromine, chlorine, and combinations thereof. The electrochemically active species 24, 28 could also be organic molecules or macromolecules that contain groups that undergo electrochemically reversible reactions, such as quinones or nitrogen-containing organics, such as quinoxalines or pyrazines. The electrolytes 22, 26 are solutions that include one or more of the electrochemically active species 24, 28. The first electrolyte solution 22 and the second electrolyte solution 26 are contained in a supply, storage system 30 that includes first and second vessels 32 and 34. Specifically, the first electrolyte solution 22 is contained within the first vessel 32 and the second electrolyte solution 26 is contained within the second vessel 34.

The electrolyte solutions 22, 26 are circulated by pumps 35 to at least one redox flow cell 36 of the RFB 20 through respective feed lines 38, and are returned from the cell 36 to the vessels 32, 34 via respective return lines 40. As can be appreciated, additional pumps 35 can be used if needed, as well as valves (not shown) at the inlets/outlets of the components of the RFB 20 to control flow. In this example, the feed lines 38 and the return lines 40 connect the vessels 32, 34 in respective circulation loops L1, L2 with first and second electrodes 42, 44. Multiple cells 36 can be provided as a stack within the circulation loops L1, L2.

In the examples that follow, the first electrode 42 corresponds to an anode 42 and the circulating first electrolyte solution 22 is a negative anolyte 22. Additionally, the second electrode 44 corresponds to a cathode 44 and the circulating second electrolyte solution 26 is a positive catholyte 26. In many RFB 20 chemistries, such as vanadium or iron-based systems, side reactions (e.g., with carbon electrodes, water in the system, etc.) can create imbalances in the state of the charge of the anolyte 22 and catholyte 26 and/or produce gaseous byproducts 46, 47 that accumulate in a headspace of the first vessel 32 containing anolyte and headspace of the second vessel 34 containing catholyte 26, respectively. For example, hydrogen, oxygen, carbon dioxide, water vapor, or other gaseous byproducts 46 may be produced as a result of these side reactions, depending on the anolyte 22 and catholyte 26 used for the RFB 20. The gaseous byproducts 46, 47 can accumulate and potentially disrupt the desired operation of the RFB 20 by altering the state of charge (“SOC”) and/or the pH of the anolyte 22 and catholyte 26. Thus, as described in more detail below, one function of the ancillary cell 18 is to eliminate the gaseous byproducts 46, 47 by returning charge carriers from the gaseous byproducts 46, 47 to the anolyte 22 and catholyte 26 in order to facilitate maintaining a desired SOC and/or pH.

The cell 36 includes the anode 42, the cathode 44 spaced apart from the anode 42, and a barrier layer 48 arranged between the anode 42 and the cathode 44. For example, the anode 42 and cathode 44 may be porous electrically-conductive structures, such as carbon paper or felt. The cell 36 further includes first and second flow fields (not shown) that are adjacent the anode 42 and cathode 44, respectively. The flow fields may include channels (not shown) for delivering the anolyte 22 and catholyte 26 to the anode 42 and cathode 44, respectively.

The barrier layer 48 can be, but is not limited to, an ionic-exchange membrane, a micro-porous polymer membrane, or an electrically insulating microporous matrix of a material, such as silicon carbide (SiC), that prevents the anolyte 22 and catholyte 26 from freely and rapidly mixing but permits selected ions to pass through to complete the redox reactions while electrically isolating the anode 42 and cathode 44. In this regard, the circulation loops L1, L2 are isolated from each other during normal operation, such as charge, discharge and shutdown states.

The anolyte 22 and catholyte 26 may be delivered to, and circulate through, the cell 36 or cells 36 during an active charge mode and discharge mode to either convert electrical energy into chemical energy or, in the reverse reaction, convert chemical energy into electrical energy that is discharged. The electrical energy is transmitted to and from the cell 36 or cells 36 through an external electric circuit 49 that is electrically coupled with the electrodes 42, 44.

The ancillary cell 18 includes a first flow field 50 and a first end plate 51. Further, the ancillary cell 18 includes a second flow field 52 and a second end plate 53. The first and second end plates 51, 53 provide structural support to the ancillary cell 18 and define its outer lateral boundaries. Each of the first and second flow fields 50, 52 include channels 54, 56 that communicate a flow of anolyte 22, catholyte 26, or gaseous byproducts 46, 47 through the ancillary cell 18 and optimize ion exchange between the flow and first and second ancillary cell electrodes 58, 60. The first flow field 50 is arranged adjacent to and between the first ancillary cell electrode 58 and a first current collector 61. Thus, the first current collector 61 is arranged between the first end plate 51 and the first flow field 50. The second flow field 52 is arranged adjacent to and between a second ancillary cell electrode 60 and a second current collector 62. Thus, the second current collector 62 is arranged between the second end plate 53 and the second flow field 52. The first and second current collectors 61, 62 facilitate the transfer of electrons between the flow of anolyte 22, catholyte 26, and gaseous byproducts 46, 47 via an external electric circuit 67. Additionally, a first membrane 63 and a second membrane 64 are arranged adjacent to the first and second ancillary cell electrode 58 and 60, respectively. The first and second membrane 63 and 64 may be a similar material as that described above for the barrier membrane 48 used in the RFB 20. A barrier electrolyte chamber 66 is arranged between the first membrane 63 and the second membrane 64, and the barrier electrolyte chamber 66 is configured to receive a barrier electrolyte solution 68.

The barrier electrolyte 68 is operable to enable some active species 24, 28 to diffuse through the barrier electrolyte chamber 66 and into the opposing ancillary cell electrode 58 or 60 but prevent or limit migration of other ions into the opposing ancillary cell electrode 58 or 60 that would be considered to be contaminants. Examples of contaminant ions are sulfur-containing species or organic acids that could poison Pt catalysts used to oxidize or reduce byproduct gasses 46, 47 such as hydrogen or oxygen respectively. Acting as a transport barrier, the barrier electrolyte 68 provides high concentrations of non-contaminating charge carrier species while diluting contaminant species and lowering the flux via a smaller concentration gradient of these contaminants in order to better maintain distinct electrochemical environments in the ancillary cell 18. Thus, incorporation of the barrier electrolyte 68 offers protection to both the anolyte 22 and catholyte 26 flowing through the ancillary cell 18. The barrier electrolyte 68 is selected from a group consisting of hydrogen chloride, sulfuric acid, salts containing lithium, sodium, potassium, cesium, magnesium, calcium cations and halide, hydroxide, sulfur-containing, nitrogen-containing, and carbon-containing anions., and combinations thereof. In one example where a gaseous byproduct 46, 47 is oxidized, the barrier electrolyte 68 may be a solution of 1.0 molar sodium chloride, 0.1 molar perchloric acid, or 1.0 molar sodium hydroxide.

To maintain the ancillary cell 18 in good working condition, the concentration of ions and other contaminants that have diffused into the barrier electrolyte 68 from the gaseous byproducts 46, anolyte 22, and/or catholyte 26 are monitored and adjusted. For example, when the concentration of ions and other contaminants in the barrier electrolyte solution 68 exceeds a threshold, the barrier electrolyte 68 is either replaced or treated to remove the ions or contaminants. In one example, the barrier electrolyte 68 is maintained as a stagnant volume within the barrier electrolyte chamber 66 and is periodically flushed and replaced with fresh barrier electrolyte solution 68. In this context, “fresh” refers to either a new barrier electrolyte 68 that has a lower concentration of ions and contaminants than the flushed barrier electrolyte solution 68, or the same barrier electrolyte solution 68 that has been flushed but then treated to reduce the concentration of ions and contaminants. For example, the barrier electrolyte solution 68 is continuously or periodically circulated through the barrier electrolyte chamber 66 and a separate treatment chamber 80. The treatment chamber 80 is configured to purify the barrier electrolyte 68. As such, a return line 82 and a feed line 84 (see FIG. 1) fluidly connects the treatment chamber 80 and barrier electrolyte chamber 68. A combination of these two approaches may also be used, allowing for both periodic replacement with a fresh barrier electrolyte solution 68 and circulation of the barrier electrolyte solution 68 through the treatment chamber 80 as needed.

The ancillary cell 18 may be configured as a recombination cell, a pH management cell, or a SOC management cell. While configured as a recombination cell, the ancillary cell 18 consumes one or both of the gaseous byproducts 46, 47. As a pH management cell, the ancillary cell 18 is configured to electrolyze water to generate protons or hydroxide ions to manage the pH of the anolyte 22 and catholyte 26. As a SOC management cell, the ancillary cell 18 is configured to perform a redox reaction to maintain a SOC balance between the anolyte 22 and catholyte 26 that is optimal for the RFB 20. Thus, the ancillary cell 18 “treats” either one or both of the anolyte 22 and catholyte 26 in each configuration of the recombination cell, pH management cell and SOC management cell. Depending on its configuration, the ancillary cell 18 may be in direct fluid communication with either or both of the first vessel 32 and the second vessel 34. Additionally, in one configuration as a pH management cell, the ancillary cell 18 receives water or carbon dioxide from an external source. Thus, whether a flow of anolyte 22, catholyte 26, gaseous byproducts 46, 47, or water is routed to the ancillary cell 18 depends on the configuration of the ancillary cell 18 as a recombination cell, pH management cell, or SOC management cell. Accordingly, the materials of the first and second ancillary cell electrodes 58, 60, the first and second membranes 63, 64, and the composition of the barrier electrolyte 68 can be tailored based on the configuration of the ancillary cell 18 and the flow within it. In each configuration of the ancillary cell 18.

FIG. 1 shows one embodiment of the ancillary cell 18 in a SOC management configuration. In this configuration, the ancillary cell 18 is configured to receive the anolyte 22 through its first flow field 50 and catholyte 26 through its second flow field 52. The ancillary cell 18 is connected to the first and second vessels 32, 34 by first and second supply lines 70, 74, respectively, that provide flow of anolyte 22 and catholyte 26 to the ancillary sell 18, respectively. The first and second supply lines 70, 74 have an inlet that opens to the first and second vessels 32, 34, respectively, and an outlet that opens to the first and second flow fields 50, 52, respectively. The first vessel 32 is also connected to the ancillary cell 18 by a first outlet line 72 that routes flow from the ancillary cell 18 back to the first vessel 32. Additionally, the second vessel 34 is connected to the ancillary cell 18 by a second outlet line 76 that routes flow from the ancillary cell 18 back to the second vessel 34. Further, the first and second outlet lines 72, 76 have an inlet that opens to the first and second flow fields 50, 52, respectively, of the ancillary cell 18 and an outlet that opens to the first and second vessels 32, 34, respectively.

Referring to the embodiment of the ancillary cell 18 of FIG. 1, the anolyte 22 is oxidized and the resulting electrons are directed through the external electrical circuit 67 to the second flow field 52, where they facilitate electrochemical reduction of the active species 28 in the catholyte 26. Charge carriers will migrate through the membrane separators 63, 64 and barrier electrolyte 68 to maintain electroneutrality. Further, contaminant ions, other active species 28 from the catholyte 26, and active species 24 from the anolyte 22 may diffuse across the membranes 64 and 63, respectively, into the barrier electrolyte chamber 66, and are diluted by the barrier electrolyte 68. Accordingly, the barrier electrolyte 68 works to prevent or limit migration of those contaminant ions and other actives species 28, 24 between the electrodes 58, 60.

A measurement device and controller (not shown) may be incorporated within the system 10 to measure an operating parameter such as conductivity, pH or the concentration of ions and the active species 24, 28 in the anolyte 22, the catholyte 26, and/or the barrier electrolyte 68, and responsively adjust the operation of the ancillary cell 18 accordingly, as described further below. It is to be understood that such a measurement device and controller may be incorporated into each example system 10 shown in FIGS. 1-8.

The system 10 provides a method for balancing the pH and SOC for the anolyte 22 and catholyte 26. This method for balancing the SOC of the anolyte 22 and catholyte 26 includes passing the anolyte 22, catholyte 26 and/or gaseous byproducts 46, 47 through the ancillary cell 18. The method further includes oxidizing the anolyte 22 or gaseous byproduct 46 and reducing the catholyte 26 to provide a reduced catholyte 26. The method may also include monitoring one or more operating parameters of the anolyte 22, the catholyte 26, and/or barrier electrolyte 68 by measuring the one or more operating parameters to obtain a measured value, and comparing the measured values to stored, threshold values that indicate acceptable operating conditions for the anolyte 22, the catholyte 26, and/or barrier electrolyte 68. The method further includes, returning the treated anolyte 22 and catholyte 26 to the first vessel 32 and second vessel 34, respectively. Accordingly, the method includes adjusting the operation of the ancillary cell 18 if the measured value exceeds the stored, threshold value for that operating parameter. It is to be understood that “exceeds” could mean a value above or below the threshold value or outside of a threshold value range. Adjusting the operation of the ancillary cell 18 may include, for example, adjusting flow rates of the gaseous byproducts 46, anolyte 22, and/or catholyte 26; evacuating a volume of the barrier electrolyte 68 to treat the volume of the barrier electrolyte 68 and returning the volume of treated barrier electrolyte 68 to the barrier electrolyte chamber 66; or evacuating a volume of the barrier electrolyte 68 in the barrier electrolyte chamber 66 and providing a fresh volume of barrier electrolyte 68 to the barrier electrolyte chamber 66, or applying a potential or current across the ancillary cell, allowing the cell to discharge freely or not.

A method for balancing the pH of the anolyte 22 and catholyte 26 is also provided. The method includes passing a portion of the anolyte 22 in the first vessel 32 or passing a portion of the catholyte 26 into the ancillary cell 18. Further, the method includes passing an electrolyzable solution into an electrolysis chamber and electrolyzing the electrolyzable solution to produce hydroxide ions (OH⁻) and hydrogen ions (H⁺). A solution is considered “electrolyzable” if it can undergo an electrochemical reaction when subjected to an electric current, such as water or carbon dioxide. The method may also include monitoring one or more operating parameters of the anolyte 22, the catholyte 26, and/or barrier electrolyte 68, such as the pH thereof, by measuring the one or more operating parameters to obtain a measured value, and comparing the measured values to stored, threshold values that indicate acceptable operating conditions for the anolyte 22, the catholyte 26, and/or barrier electrolyte 68. Accordingly, the method includes selectively providing the hydroxide ions and hydrogen ions into the barrier electrolyte 68 and/or the portion of the anolyte 22 and catholyte 26 passing through the ancillary cell 18 if the measured value exceeds the stored, threshold value for that operating parameter. It is to be understood that “exceeds” could mean a value above or below the threshold value or outside of a threshold value range. The method further includes, returning the treated anolyte 22 and catholyte 26 to the first vessel 32 and second electrolyte storage vessel 34, respectively. Also, the method includes adjusting the operation of the ancillary cell 18 based whether the measured value exceeds the stored, threshold value for that operating parameter. Adjusting the operation of the ancillary cell 18 may include, for example, adjusting flow rates of anolyte 22, and/or catholyte 26 to the ancillary cell 18; evacuating a volume of the barrier electrolyte 68 to treat the volume of the barrier electrolyte 68 and returning the volume of treated barrier electrolyte 68 to the barrier electrolyte chamber 66; or evacuating a volume of the barrier electrolyte 68 in the barrier electrolyte chamber 66 and providing a fresh volume of barrier electrolyte 68 to the barrier electrolyte chamber 66.

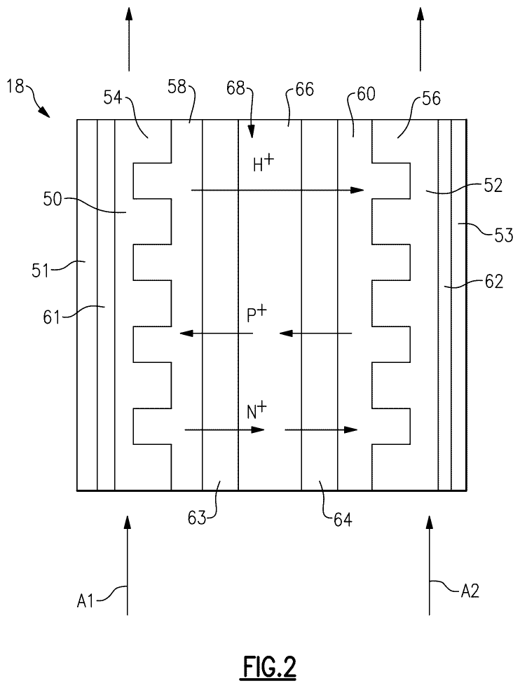

FIG. 2 illustrates an example of the ancillary cell 18 with ions diffusing across the membranes 63, 64 and single barrier electrolyte chamber 66 containing barrier electrolyte solution 68. Each of the first and second flow fields 50 and 52 includes channels 54 and 56, respectively. Arrows A1 and A2 represent the general direction of flow through the first flow field 50 and the second flow field 52, respectively.

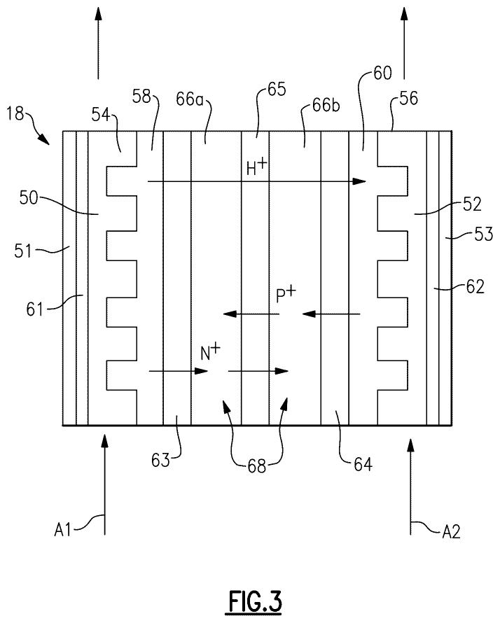

FIG. 3 illustrates another example of an ancillary cell 18 that includes a third membrane separator 65 arranged in the barrier electrolyte chamber 66. The third membrane separator 65 partitions the barrier electrolyte chamber 66 into two sub-chambers 66a and 66b. Incorporating a third membrane separator 65 provides enhanced separation capabilities and further controls the diffusion of active species 24, 28, along with other ions generated by the oxidation-reduction reactions in the ancillary cell 18.

It is to be understood that the examples of ancillary cells 18 illustrated in FIGS. 2-3 may be used in the example redox flow battery systems 10, 100, 200, 300, 400, 500 of FIG. 1 and FIGS. 4-8, respectively. With respect to FIGS. 1-8, it is to be understood that other configurations for fluidly connecting the ancillary cell 18 to the circulation loops L1, L2 and/or the storage system 30 are within the scope of this disclosure. Accordingly, valves (not shown) may be provided along the first and second supply lines 70, 74, and first and second outlet lines 72, 76 to facilitate the flow of anolyte 22, catholyte 26 and gaseous byproducts 46, 47 between the ancillary cell 18 and the redox flow cell 36, first vessel 32, and second vessel 34 depending on the configuration of the ancillary cell 18. Additionally, pumps (not shown) may be incorporated within the first and second supply lines 70, 74, and/or the first and second outlet lines 72, 76 to pump the anolyte 22, gaseous byproducts 46, 47 and catholyte 26 through the battery system 10.

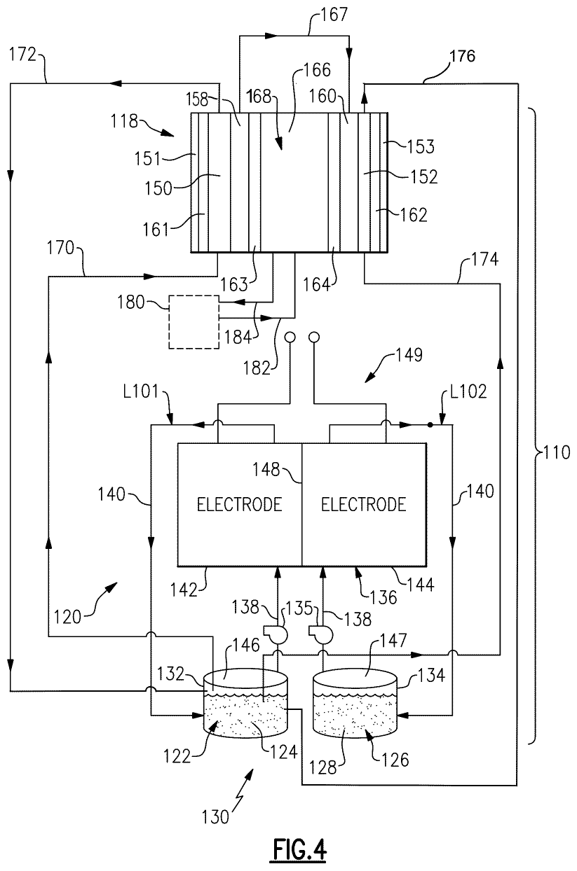

FIG. 4 shows one example redox flow battery system 110 with an ancillary cell 118 configured as a recombination cell. In this example, the ancillary cell 118 is in fluid communication with first and second supply lines 170, 174 and first and second outlet lines 172, 176. The first supply line 170 is configured to communicate gaseous byproduct 146 and has an inlet that opens to the first vessel 132 and an outlet that opens to the first flow field 150. The first outlet line 172 is configured to communicate residual gaseous byproduct 146 and other inert gases from the ancillary cell 118 back to the first vessel 132. Thus, the first outlet line 172 has an inlet that opens to the first flow field 150 and an outlet that opens to the first vessel 132. The second supply line 174 is configured to communicate anolyte 122 and has an inlet that opens to the first vessel 132 and an outlet that opens to the second flow field 152. The second outlet line 176 is configured to communicate treated anolyte 122 back to the first vessel 132 and has an inlet open to the second flow field 152 and an outlet open to the first vessel 132. In this example, the ancillary cell 118 is configured to consume the gaseous byproduct 146 and eliminate a portion of the gaseous byproduct 146 from the system 110. By coupling the oxidation of the gaseous byproduct 146 with the reduction of the anolyte 122, the ancillary cell 118 can mitigate a change in SOC of the anolyte 122 from an optimal SOC for operation of the RFB 120. The resulting electrons are directed through the external electrical circuit 167 from the first flow field 150 to the second flow field 152, where they facilitate the electrochemical reduction of the active species 124 in the anolyte 122. Further, other ions from the gaseous byproduct 146 and active species 124 from the anolyte 122 may diffuse across the membranes 163 and 164, respectively, into the barrier electrolyte chamber 166, and are diluted by the barrier electrolyte 168.

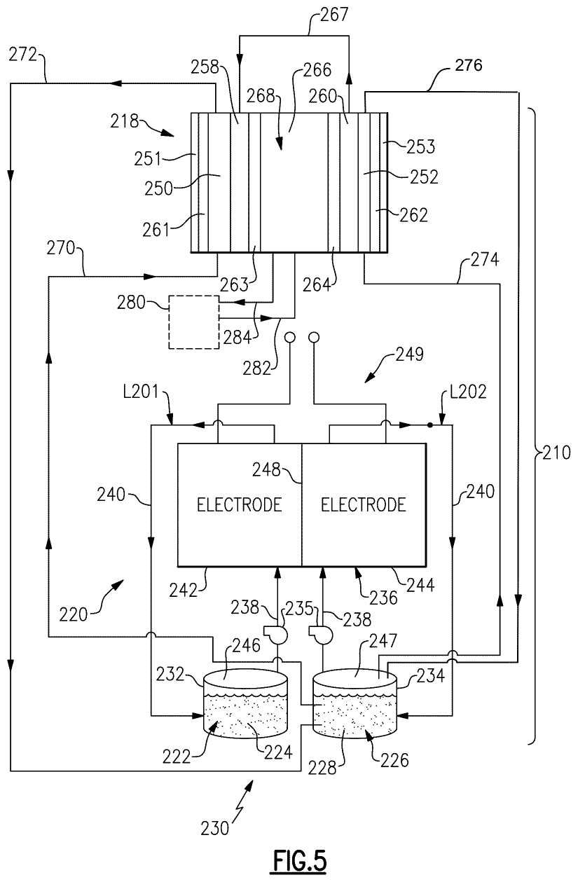

FIG. 5 shows another example of the redox flow battery system 210 with the ancillary cell 218 configured as a recombination cell. In this example the ancillary cell 218 is in fluid communication with first and second supply lines 270, 274 and first and second outlet lines 272, 276. The first supply line 270 is configured to communicate catholyte 226 to the ancillary cell 218 and has an inlet that opens to the second vessel 234 and an outlet that opens to the first flow field 250. The second supply line 274 is configured to communicate gaseous byproduct 247 and has an inlet that opens to the second vessel 234 and an outlet that opens to the second flow field 252. The first outlet line 272 is configured to communicate treated catholyte 226 and has inlet open to the first flow field 250 and an outlet open to the second vessel 234. The second outlet line 276 is configured to communicate residual gaseous byproduct 247 and other inert gases from the ancillary cell 218 back to the second vessel 234. Thus, the second outlet line 276 has an inlet that opens to the second flow field 252 and an outlet that opens to the second vessel 234. In this example, the ancillary cell 218 is configured to consume a portion of the gaseous byproduct 247 and eliminate the gaseous byproduct 247 from the system 210. By coupling the oxidation of the gaseous byproduct 247 with the reduction of the catholyte 226, the ancillary cell 118 can mitigate a change in SOC of the catholyte 226 from an optimal SOC for operation of the RFB 220. The resulting electrons are directed through the external electrical circuit 267 from the second flow field 252 to the first flow field 250, where they facilitate the electrochemical reduction of the active species 228 in the catholyte 226. Further, other ions from the gaseous byproduct 247 and active species 228 from the catholyte 226 may diffuse across the membranes 264 and 263, respectively, into the barrier electrolyte chamber 266, and are diluted by the barrier electrolyte 268.

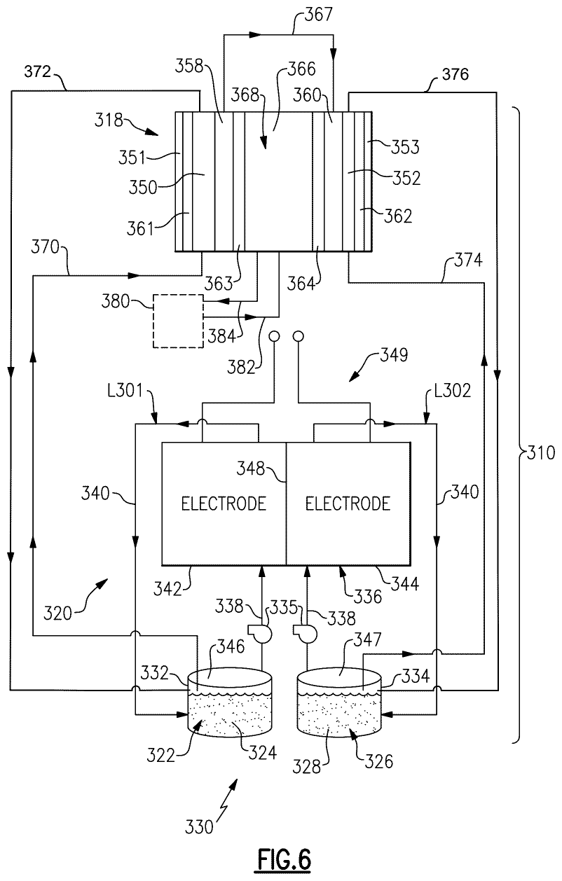

FIG. 6 shows another example of the redox flow battery system 310 with an ancillary cell 318 configured as a recombination cell. In this example the ancillary cell 318 is in fluid communication with the first and second supply lines 370, 374 and first and second outlet lines 372, 376. The first supply line 370 is configured to communicate gaseous byproduct 346 and has an inlet that opens to the first vessel 332 and an outlet that opens to the first flow field 350. The second supply line 374 is configured to communicate gaseous byproduct 347 and has an inlet that opens to the second vessel 334 and an outlet that opens to the second flow field 352. The first outlet line 372 is configured to communicate residual gaseous byproduct 346 and other inert gases from the ancillary cell 318 back to the first vessel 332. Thus, the first outlet line 372 has an inlet that opens to the first flow field 350 and an outlet that opens to the first vessel 332. The second outlet line 376 is configured to communicate residual gaseous byproduct 347 and other inert gases from the ancillary cell 318 back to the second vessel 334. Thus, the second outlet line 376 has an inlet that opens to the second flow field 352 and an outlet that opens to the second vessel 334. In this example, the ancillary cell 318 is configured to consume a portion of the gaseous byproducts 346, 347 and eliminate the gaseous byproducts 346, 347 from the system 310. Specifically, the ancillary cell 318 does so by coupling the oxidation of the gaseous byproduct 346 from the first vessel 332 containing anolyte 322 with the reduction of the gaseous byproduct 347 from the second vessel 334 containing catholyte 326. Further, other ions from the gaseous byproducts 346, 347 diffuse across the membranes 363 and 364, respectively, into the barrier electrolyte chamber 366, and are diluted by the barrier electrolyte 368.

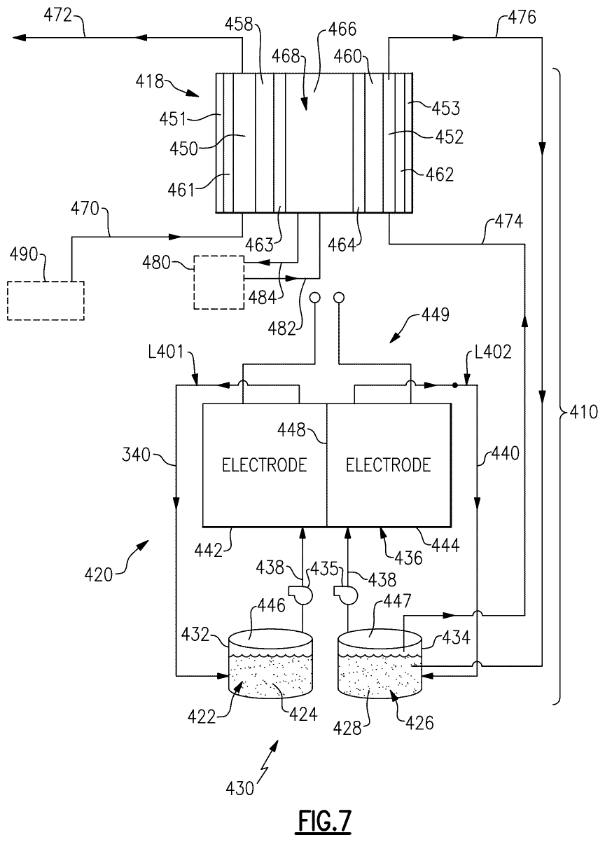

FIG. 7 shows an example of a redox flow battery system 410 with an ancillary cell 418 configured as a pH management cell. Depending on the RFB 420 chemistry (e.g., vanadium, zinc-bromine, etc.), the composition of the catholyte 426 and anolyte 422 might require specific pH ranges for reaction efficiency. In this configuration as a pH management cell, the ancillary cell 418 electrolyzes an electrolyzable solution, such as water or carbon dioxide, in an electrolysis chamber (not shown) and generates protons or hydroxide ions to manage the pH of the catholyte 426 or anolyte 422. The electrolysis chamber may be arranged either external to the ancillary cell 418 or within it, such as adjacent to one of the flow fields 450, 452. Electrolyzable solutions, such as water or carbon dioxide may be supplied from a reservoir 490 or produced as a byproduct of the redox reactions in the RFB 420. At the anode side of the electrolysis chamber, the electrolyzable solution can be oxidized to produce protons. At the cathode side, the electrolyzable solution can be reduced to produce hydroxide ions. As such, the hydrogen protons and hydroxide ions can be selectively introduced into the anolyte 422 and catholyte 426 as necessary. The gases produced in the electrolysis process are separated and vented from the ancillary cell 418, or they may be stored if needed. This prevents the produced hydrogen and oxygen gases from mixing with the anolyte 422 or catholyte 426 and affecting its properties.

As shown in FIG. 7, the ancillary cell 418 is configured to manage the pH of the catholyte 426. The ancillary cell 418 is in fluid communication with the first and second supply lines 470, 474 and first and second outlet lines 472, 476. The first supply line 470 is configured to communicate the supply of electrolyzable solution, such as water or carbon dioxide to the ancillary cell 418 and has an inlet that opens to the reservoir 490 and an outlet that opens to an electrolysis chamber adjacent the first flow field 450. The second supply line 474 is configured to communicate catholyte 426 to the ancillary cell 418 and has an inlet that opens to the second vessel 434 and an outlet that opens to the second flow field 452. The first outlet line 472 vents the gases produced as a result of the electrolysis process out of the system 410. The second outlet line 476 is configured to communicate treated catholyte 426 back to the second vessel 434 and has an inlet open to the second flow field 452 and an outlet open to the second vessel 434.

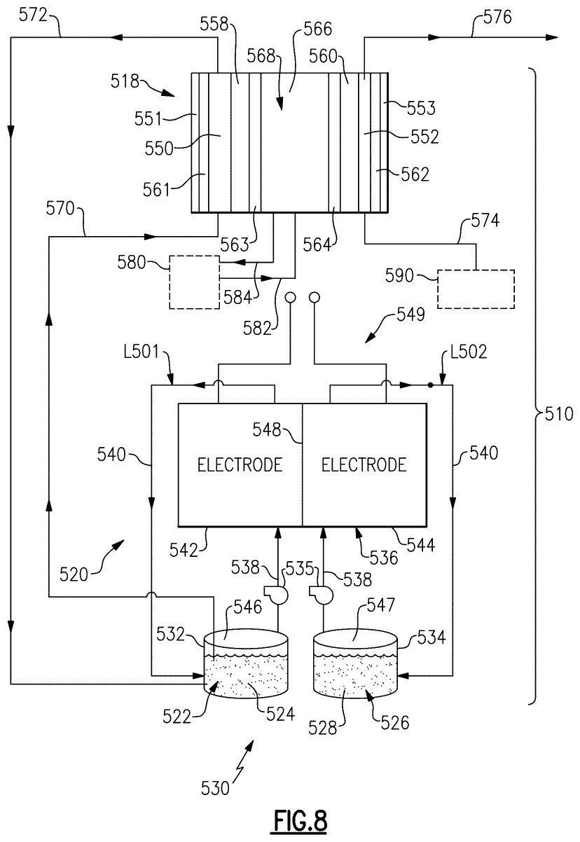

FIG. 8 shows another example of the redox flow battery system 510 with the ancillary cell 518 configured to manage pH, as explained above, of the anolyte 522. The ancillary cell 518 is in fluid communication with the first and second supply lines 570, 574 and first and second outlet lines 572, 576. The first supply line 570 is configured to communicate anolyte 522 to the ancillary cell 518 and has an inlet that opens to the first vessel 532 and an outlet that opens to the first flow field 550. The second supply line 574 is configured to communicate the supply of water or carbon dioxide to the ancillary cell 518 and has an inlet that opens to the reservoir 590 and an outlet that opens to an electrolysis chamber (not shown) within the second flow field 552. The first outlet line 572 is configured to communicate treated anolyte 522 back to the first vessel 532 and has an inlet that opens to the first flow field 550 and an outlet that opens to the first vessel 532. The second outlet line 576 vents the gases produced as a result of the electrolysis process out of the system 510.

It is to be understood that one or more configurations of the ancillary cells 18, 118, 218, 318, 418, and 518 may be provided in any one of redox flow battery systems 10, 110, 210, 310, 410, and 510 of FIG. 1 and FIGS. 4-8. For example, the ancillary cell 418 configured to manage the pH of the catholyte 426 may be combined in the same redox flow battery system 210 with the ancillary cell 218 configured as a recombination cell for consuming the gaseous byproduct 247 of the second vessel 234.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A redox flow battery system comprising:
a redox flow battery; and
an ancillary cell fluidly connected with the redox flow battery, the ancillary cell comprising a barrier electrolyte chamber containing a barrier electrolyte solution, the ancillary cell configured to treat at least one of a positive electrolyte solution or a negative electrolyte solution of the redox flow battery by adjusting at least one of a state of charge or a pH of the positive electrolyte solution or negative electrolyte solution.

2. The redox flow battery system of claim 1, the ancillary cell further comprising:
a first flow field and a first electrode arranged adjacent to the first flow field;
a second flow field and a second electrode arranged adjacent to the second flow field;
a first membrane arranged adjacent to the first electrode; and
a second membrane arranged adjacent to the second electrode
wherein the barrier electrolyte chamber arranged between the first membrane and the second membrane.

3. The redox flow battery system of claim 1, wherein the barrier electrolyte solution is selected from a group consisting of hydrogen chloride, sulfuric acid, salts containing lithium, sodium, potassium, cesium, magnesium, calcium cations and halide, hydroxide, sulfur-containing, nitrogen-containing, and carbon-containing anions, and combinations thereof.

4. The redox flow battery system of claim 1, wherein the barrier electrolyte chamber is fluidly connected to a treatment chamber that is configured to purify the barrier electrolyte solution circulated between the barrier electrolyte chamber and the treatment chamber.

5. The redox flow battery system of claim 1, wherein the barrier electrolyte solution is a stagnant barrier electrolyte solution.

6. The redox flow battery system of claim 2, the ancillary cell further comprising a third membrane partitioning the barrier electrolyte chamber into two sub-chambers.

7. The redox flow battery system of claim 2, wherein the redox flow battery comprises:
a cell having first and second electrodes and an ion-exchange layer arranged therebetween, the cell supporting electrochemically reversible redox reactions of the positive electrolyte solution and the negative electrolyte solution;
first and second circulation loops fluidly connected with the first and second electrodes, respectively, of the cell; and
first and second electrolyte storage vessels in the first and second circulation loops, respectively, the first electrolyte storage vessel containing the negative electrolyte solution and a first byproduct gas, and the second electrolyte storage vessel containing the positive electrolyte solution and a second byproduct gas.

8. The redox flow battery system of claim 7, further comprising:
a first feed line fluidly connecting the first electrolyte storage vessel with the first flow field of the ancillary cell, the first feed line operable to communicate the negative electrolyte solution from the first electrolyte storage vessel to the first flow field of the ancillary cell;
a second feed line fluidly connecting the second electrolyte storage vessel with the second flow field of the ancillary cell, the second feed line operable to communicate the positive electrolyte solution from the second electrolyte storage vessel to the second flow field of the ancillary cell;
a first return line fluidly connecting the first flow field of the ancillary cell and the first electrolyte storage vessel, the first return line operable to communicate treated positive electrolyte solution from the first flow field of the ancillary cell to the first electrolyte storage; and
a second return line fluidly connecting the second flow field with the second electrolyte storage vessel, the second return line operable to communicate treated negative electrolyte solution from the second flow field to the second electrolyte storage vessel.

9. The redox flow battery system of claim 7, further comprising:
a first feed line fluidly connecting the first electrolyte storage vessel with the first flow field of the ancillary cell, the first feed line operable to communicate the first byproduct gas from the first electrolyte storage vessel to the first flow field of the ancillary cell;
a second feed line fluidly connecting the first electrolyte storage vessel with the second flow field of the ancillary cell, the second feed line operable to communicate the negative electrolyte solution from the first electrolyte storage vessel to the second flow field of the ancillary cell;
a first return line fluidly connecting the first flow field of the ancillary cell with the first electrolyte storage vessel, the first return line operable to communicate residual first byproduct gas from the first flow field of the ancillary cell to the first electrolyte storage; and
a second return line fluidly connecting the second flow field of the ancillary cell with the first electrolyte storage vessel, the second return line operable to communicate treated negative electrolyte solution from the second flow field of the ancillary cell to the first electrolyte storage.

10. The redox flow battery system of claim 7, further comprising:
a first feed line fluidly connecting the second electrolyte storage vessel with the first flow field of the ancillary cell, the first feed line operable to communicate the positive electrolyte solution from the first electrolyte storage vessel to the first flow field of the ancillary cell;
a second feed line fluidly connecting the second electrolyte storage vessel with the second flow field of the ancillary cell, the second feed line operable to communicate the second byproduct gas from the second electrolyte storage vessel to the second flow field of the ancillary cell;
a first return line fluidly connecting the first flow field of the ancillary cell with the second electrolyte storage vessel, the first return line operable to communicate treated positive electrolyte solution from the first flow field of the ancillary cell to the second electrolyte storage vessel; and
a second return line fluidly connecting the second flow field of the ancillary cell with the second electrolyte storage vessel, the second return line operable to communicate residual second byproduct gas from the second flow field of the ancillary cell to the second electrolyte storage vessel.

11. The redox flow battery system of claim 7, further comprising:
a first feed line fluidly connecting the first electrolyte storage vessel with the first flow field of the ancillary cell, the first feed line operable to communicate the first byproduct gas from the first electrolyte storage vessel to the first flow field of the ancillary cell;
a second feed line fluidly connecting the second electrolyte storage vessel with the second flow field of the ancillary cell, the second feed line operable to communicate the second byproduct gas from the second electrolyte storage vessel to the second flow field of the ancillary cell;
a first return line fluidly connecting the first flow field of the ancillary cell with the first electrolyte storage vessel, the first return line operable to communicate residual first byproduct gas from the first flow field of the ancillary cell to the first electrolyte storage vessel; and
a second return line fluidly connecting the second flow field of the ancillary cell with the second electrolyte storage vessel, the second return line operable to communicate residual second byproduct gas from the second flow field of the ancillary cell to the second electrolyte storage vessel.

12. The redox flow battery system of claim 7, further comprising:
a reservoir containing an electrolyzable solution;
a first feed line fluidly connecting the reservoir with an electrolysis chamber arranged within the ancillary cell, the first feed line operable to communicate the electrolyzable solution from the reservoir to the electrolysis chamber;
a second feed line fluidly connecting the second electrolyte storage vessel with the second flow field of the ancillary cell, the second feed line operable to communicate the positive electrolyte solution from the second electrolyte storage vessel to the second flow field of the ancillary cell;
a vent line fluidly connected to the electrolysis chamber, the vent line operable to communicate gases from the electrolysis chamber out of the ancillary cell; and
a return line fluidly connecting the second flow field of the ancillary cell and the second electrolyte storage vessel, the return line operable to communicate treated positive electrolyte solution from the second flow field of the ancillary cell to the second electrolyte storage vessel.

13. The redox flow battery system of claim 7, further comprising:
a reservoir containing an electrolyzable solution;
a first feed line fluidly connecting the reservoir with an electrolysis chamber arranged within the ancillary cell, the first feed line operable to communicate the electrolyzable solution from the reservoir to the electrolysis chamber;
a second feed line fluidly connecting the first electrolyte storage vessel with the first flow field of the ancillary cell, the second feed line operable to communicate the negative electrolyte solution from the first electrolyte storage vessel to the first flow field of the ancillary cell;
a vent line fluidly connected to the electrolysis chamber, the vent line operable to communicate gases from the electrolysis chamber out of the ancillary cell; and
a return line fluidly connecting the first flow field of the ancillary cell and the first electrolyte storage vessel, the return line operable to communicate treated negative electrolyte solution from the first flow field of the ancillary cell to the first electrolyte storage vessel.

14. A redox flow battery system comprising:
a redox flow battery including a cell having first and second electrodes and an ion-exchange layer arranged there between, the cell supporting electrochemically reversible redox reactions of a positive electrolyte solution and a negative electrolyte solution;
first and second circulation loops fluidly connected with the first and second electrodes, respectively, of the cell;
first and second electrolyte storage vessels in the first and second circulation loops, respectively, the first electrolyte storage vessel containing the negative electrolyte solution and the second electrolyte storage vessel containing the positive electrolyte solution; and
at least one ancillary cell fluidly connected with the redox flow battery, the at least one ancillary cell configured to treat at least one of the positive electrolyte solution or the negative electrolyte solution of the redox flow battery by adjusting at least one of a state of charge or a pH of the positive electrolyte solution or negative electrolyte solution.

15. The redox flow battery of claim 14, the at least one ancillary cell further comprising:
a first flow field and a first electrode arranged adjacent to the first flow field;
a second flow field and a second electrode arranged adjacent to the second flow field;
a first membrane arranged adjacent to the first electrode;
a second membrane arranged adjacent to the second electrode; and
a barrier electrolyte chamber containing a barrier electrolyte solution, the barrier electrolyte chamber arranged between the first membrane and the second membrane
wherein the at least one ancillary cell includes a first ancillary cell and a second ancillary cell, the first ancillary cell operable to adjust the state of charge of one of the positive electrolyte solution or the negative electrolyte solution and the second ancillary cell operable to adjust the pH of one of the positive electrolyte solution or the negative electrolyte solution.

16. A method for a redox flow battery system, the method comprises:
feeding a first electrolyte solution or a first byproduct gas in circulation with a redox flow battery into an ancillary cell;
oxidizing the first electrolyte solution or the first byproduct gas in the ancillary cell to produce free electrons and ions;
feeding a second electrolyte solution or a second byproduct gas into the ancillary cell; and
reducing the second electrolyte solution or the second byproduct gas in the ancillary cell.

17. The method of claim 16, wherein the ancillary cell includes:
a first flow field and a first electrode arranged adjacent to the first flow field;
a second flow field and a second electrode arranged adjacent to the second flow field;
a first membrane arranged adjacent to the first electrode;
a second membrane arranged adjacent to the second electrode; and
a barrier electrolyte chamber arranged between the first membrane and the second membrane, the barrier electrolyte chamber containing a barrier electrolyte solution.

18. The method of claim 17, further comprising:
monitoring an operating parameter of the barrier electrolyte solution by generating a measured value of a property of the barrier electrolyte solution;
comparing the measured value to a threshold operating value; and
in response to the measured value exceeding the threshold operating value, evacuating the barrier electrolyte solution from the barrier electrolyte chamber and providing a fresh barrier electrolyte solution into the barrier electrolyte chamber.

19. The method of claim 18, wherein the operating parameter of the barrier electrolyte solution is at least one of an ion concentration, conductivity, or a pH value.

20. The method of claim 18, wherein the providing includes treating the barrier electrolyte solution that has been evacuated from the barrier electrolyte chamber in a treatment chamber to produce the fresh barrier electrolyte solution, and returning the fresh barrier electrolyte solution to the barrier electrolyte chamber.
